(19) United States
(12) Patent Application Publication
(10) Pub. No.: US 2011/0268206 A1
(43) Pub. Date: Nov. 3, 2011

(54) METHOD AND DEVICE OF CHANNEL ESTIMATION FOR OFDM SYSTEM

(75) Inventors: Qihong Ge, Beijing (CN); Junwei Wang, Beijing (CN); Binbin Liu, Beijing (CN); Dong Bai, Beijing (CN); Tao Tao, Beijing (CN)

(73) Assignee: Timi Technologies Co., Ltd., Haidian, Beijing (CN)

(21) Appl. No.: 13/143,664

(22) PCT Filed: Dec. 30, 2009
(86) PCT No.: PCT/CN2009/076238

§ 371 Date: Jul. 7, 2011

(30) Foreign Application Priority Data
Jan. 7, 2009 (CN) 200910076558.7

(51) Int. Cl. H04L 27/28

(52) U.S. Cl. 375/260

(57) ABSTRACT

The present invention relates to the field of communication technology. A channel estimation device for an Orthogonal Frequency Division Multiplexing (OFDM) system is provided for performing channel estimation on data based on synchronization signal and pilot, which comprises: a synchronization signal based initial channel estimation module for performing initial channel estimation based on a synchronization signal in the data; a pilot channel tracking module for performing pilot channel tracking on the result of the initial channel estimation; a noise reduction module for performing noise reduction on the result of the pilot channel tracking; and an effective sub-carrier extraction module for extracting channel estimation values of effective sub-carriers from the result of the noise reduction. With the channel estimation method and device for OFDM system according to the present invention, the channel estimation is carried out jointly based on the synchronization signal and the pilot, such that the accuracy of channel estimation can be significantly improved and the performance requirements of the system can be satisfied without increasing the density of pilots and thus reducing the amount of system payload. Moreover, the synchronization signal can still be used for its original purpose of carrier and timing synchronization.

### FIELD OF THE INVENTION

The invention relates to the field of communication technology, and more particularly, to an Orthogonal Frequency Division Multiplexing (OFDM)-based multi-carrier digital broadcast system as well as a method and device of channel estimation for an OFDM system.

### BACKGROUND OF THE INVENTION

In an OFDM-based broadcast system, channel estimation is typically carried out using pilots. High density of pilots leads to high accuracy of channel estimation, which leads to increased immunity against multi-path delay spread. However, the more energy the pilots occupy, the less payload the system may carry, which results in lower system utilization. On the other hand, low density of pilots leads to more system payload and higher system utilization which, however, comes at expense of decreased immunity against multi-path delay spread. In some extreme reception condition, e.g., in a coverage overlapping area between single frequency networks, the performance requirements of the system cannot be satisfied by channel estimation based only on pilots.

Synchronization signal is usually used in the OFDM-based broadcast system for carrier and timing synchronization. There is no solution or approach in the prior art for applying the synchronization signal to channel estimation.

### SUMMARY OF THE INVENTION

An object of the present invention is to solve the problem in the prior art that the performance requirements of the system cannot be satisfied by channel estimation based only on pilots while there is no solution for applying synchronization signal to channel estimation to fulfill the performance requirements of the system.

In order to achieve the above object, an aspect of the present invention is directed to a channel estimation device for an OFDM system, configured for performing channel estimation on data based on synchronization signal and pilot, comprising:
a synchronization signal based initial channel estimation module adapted for performing initial channel estimation based on a synchronization signal in the data to obtain an initial channel estimation result;
a pilot channel tracking module adapted for performing pilot channel tracking on the initial channel estimation result obtained from the synchronization signal based initial channel estimation module based on a pilot in the data, so as to obtain a pilot channel tracking result;
a noise reduction module adapted for performing noise reduction on the pilot channel tracking result obtained from the pilot channel tracking module; and
an effective sub-carrier extraction module adapted for extracting channel estimation values of effective sub-carriers from the noise reduced pilot channel tracking result.

In the above channel estimation device, the synchronization signal based initial channel estimation module further comprises:
a sampling sub-module adapted for sampling a frame synchronization sequence of the data to obtain sampled data;
a time/frequency domain transform sub-module adapted for performing time/frequency domain transform on the sampled data obtained from the sampling sub-module to obtain transformed domain data;
a de-randomization sub-module adapted for de-randomizing the transformed data obtained from the time/frequency domain transform sub-module to obtain de-randomized data;
an initial IFFT sub-module adapted for performing IFFT operation on the de-randomized data obtained from the de-randomization sub-module to obtain initial IFFT data;
an initial filtering sub-module adapted for performing noise reduction on the initial IFFT data obtained from the initial IFFT sub-module to obtain an initial noise reduction result;
a zero padding sub-module adapted for zero padding the initial noise reduction result obtained from the initial filtering sub-module to obtain a zero padded result; and
an initial FFT sub-module adapted for performing FFT operation on the zero padded result obtained from the zero padding sub-module to obtain the initial channel estimation result.

In the above channel estimation device, the noise reduction module further comprises:
a noise reduction IFFT sub-module adapted for performing IFFT operation on the pilot channel tracking result obtained from the pilot channel tracking module to obtain noise reduced IFFT data;
a noise reduction filtering sub-module adapted for performing noise reduction filtering on the noise reduced IFFT data obtained from the noise reduction IFFT filtering sub-module to obtain a noise reduction filtered result; and
a noise reduction FFT sub-module adapted for performing FFT operation on the noise reduction filtered result obtained from the noise reduction filtering sub-module to obtain a noise reduction result.

In order to better achieve the above object, a channel estimation method for an OFDM) system is provided for performing channel estimation on data based on synchronization signal and pilot, which comprises the steps of:
performing initial channel estimation based on a synchronization signal in the data to obtain an initial channel estimation result;
performing pilot channel tracking on the initial channel estimation result based on a pilot in the data, so as to obtain a pilot channel tracking result;
performing noise reduction on the pilot channel tracking result to obtain a noise reduction result; and
extracting channel estimation values of effective sub-carriers from the noise reduction result.

In the above channel estimation method, the step of performing initial channel estimation based on a synchronization signal in the data to obtain an initial channel estimation result comprises:
sampling a frame synchronization sequence of the data to obtain sampled data;
performing time/frequency domain transform on the sampled data to obtain transformed domain data;
de-randomizing the transformed data to obtain de-randomized data; performing IFFT operation on the de-randomized data to obtain initial IFFT data;
performing noise reduction on the initial IFFT data to obtain an initial noise reduction result;
zero padding the initial noise reduction result to obtain a zero padded result; and
performing FFT operation on the zero padded result to obtain the initial channel estimation result.

In the above channel estimation method, the step of performing noise reduction on the pilot channel tracking result to obtain a noise reduction result comprises:
performing IFFT operation on the pilot channel tracking result to obtain noise reduced IFFT data;
performing noise reduction filtering on the noise reduced IFFT data to obtain a noise reduction filtered result; and
performing FFT operation on the noise reduction filtered result to obtain the noise reduction result.

In order to better achieve the above object, an OFDM-based multi-carrier digital broadcast system is provided, which comprises a transmitting device and a receiving device, wherein the system further comprises a channel estimation device adapted for performing channel estimation on data received by the receiving device based on synchronization signal and pilot.

In the above multi-carrier digital broadcast system, the channel estimation device further comprises:
a synchronization signal based initial channel estimation module adapted for performing initial channel estimation based on a synchronization signal in the data to obtain an initial channel estimation result;
a pilot channel tracking module adapted for performing pilot channel tracking on the initial channel estimation result obtained from the synchronization signal based initial channel estimation module based on a pilot in the data, so as to obtain a pilot channel tracking result;
a noise reduction module adapted for performing noise reduction on the pilot channel tracking result obtained from the pilot channel tracking module; and
an effective sub-carrier extraction module adapted for extracting channel estimation values of effective sub-carriers from the noise reduced pilot channel tracking result.

In the above channel estimation device, the synchronization signal based initial channel estimation module further comprises:
a sampling sub-module adapted for sampling a frame synchronization sequence of the data to obtain sampled data;
a time/frequency domain transform sub-module adapted for performing time/frequency domain transform on the sampled data obtained from the sampling sub-module to obtain transformed domain data;
a de-randomization sub-module adapted for de-randomizing the transformed data obtained from the time/frequency domain transform sub-module to obtain de-randomized data;
an initial IFFT sub-module adapted for performing IFFT operation on the de-randomized data obtained from the de-randomization sub-module to obtain initial IFFT data;
an initial filtering sub-module adapted for performing noise reduction on the initial IFFT data obtained from the initial IFFT sub-module to obtain an initial noise reduction result;
a zero padding sub-module adapted for zero padding the initial noise reduction result obtained from the initial filtering sub-module to obtain a zero padded result; and
an initial FFT sub-module adapted for performing FFT operation on the zero padded result obtained from the zero padding sub-module to obtain the initial channel estimation result.

In the above channel estimation device, the noise reduction module further comprises:
a noise reduction IFFT sub-module adapted for performing IFFT operation on the pilot channel tracking result obtained from the pilot channel tracking module to obtain noise reduced IFFT data;
a noise reduction filtering sub-module adapted for performing noise reduction filtering on the noise reduced IFFT data obtained from the noise reduction IFFT filtering sub-module to obtain a noise reduction filtered result; and
a noise reduction FFT sub-module adapted for performing FFT operation on the noise reduction filtered result obtained from the noise reduction filtering sub-module to obtain a noise reduction result.

With the channel estimation method and device for OFDM system according to the present invention, the channel estimation is carried out jointly based on the synchronization signal and the pilot, such that the accuracy of channel estimation can be significantly improved and the performance requirements of the system can be satisfied without increasing the density of pilots and reducing the amount of system payload. Moreover, the synchronization signal can still be used for its original purpose of carrier and timing synchronization, such that the original function of the synchronization is not affected.

Further aspects and advantages of the present invention will be given in the following description. They will become apparent from either the following description or the implementation of the present invention.

### BRIEF DESCRIPTION OF THE DRAWINGS

The above and/or further aspects and advantages will be more apparent from the following description of embodiments with reference to the figures, in which:

FIG. 1 is a diagram showing the time domain frame structure of an OFDM system signal having a synchronization signal according to the prior art;

FIG. 2 is a diagram showing the structure in which pilots and data are multiplexed in time/frequency domain according to the prior art;

FIG. 3 is a diagram showing the structure of the satellite broadcast system according to an embodiment of the present invention;

FIG. 4 is a diagram showing the frame structure at the transmitter according to an embodiment of the present invention;

FIG. 5 is a diagram showing the structure of a synchronization signal generator in a signal generator at the transmitter according to an embodiment of the present invention;

FIG. 6 is a schematic diagram illustrating the initial state of a shift register of a complex m-sequence generator in the signal generator shown in FIG. 5;

FIG. 7 is a diagram showing the structure of a channel estimation device according to an embodiment of the present invention;

FIG. 8 is a flowchart illustrating the channel estimation method according to an embodiment of the present invention;

FIG. 9 is a flowchart illustrating the synchronization signal based initial channel estimation process according to an embodiment of the present invention; and

FIG. 10 is a flowchart illustrating the noise reduction process according to an embodiment of the present invention.

### DETAILED DESCRIPTION OF PREFERRED EMBODIMENTS

The embodiments of the present invention will be detailed in the following. The exemplary embodiments are illustrated in the figures, throughout which same or similar reference numerals refer to same or similar elements or to elements having same or similar functions. The following embodiments described with reference to the figures are exemplary only for explaining, rather than limiting, the present invention.

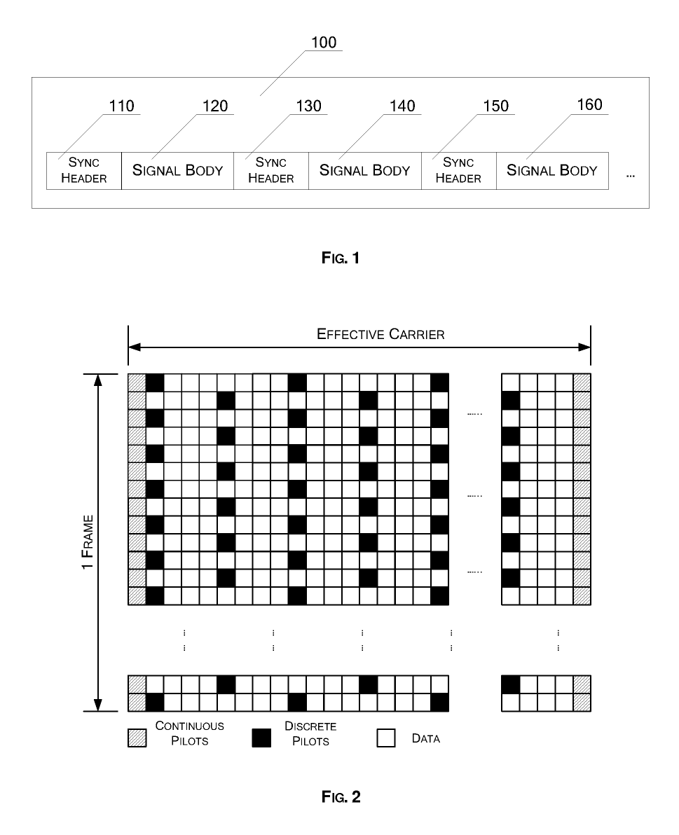

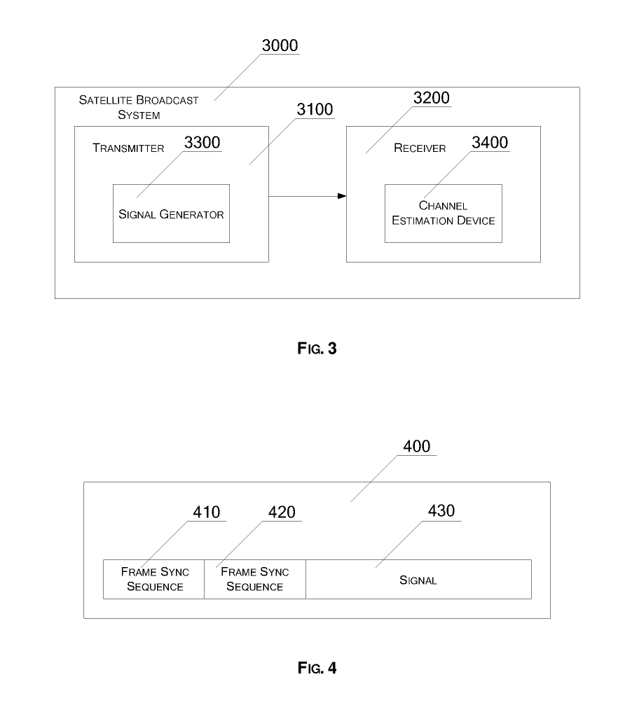

The main concept of the present invention is applicable to an OFDM system having synchronization signals and pilots. FIG. 1 shows the time domain frame structure of a signal in the system. As shown, a signal frame 100 comprises synchronization headers 110, 130, 150 . . . , and signal bodies 120, 140, 160 . . . FIG. 2 shows the structure in which pilots and data contained in the signal bodies 120, 140, 160 . . . are multiplexed in time/frequency domain.

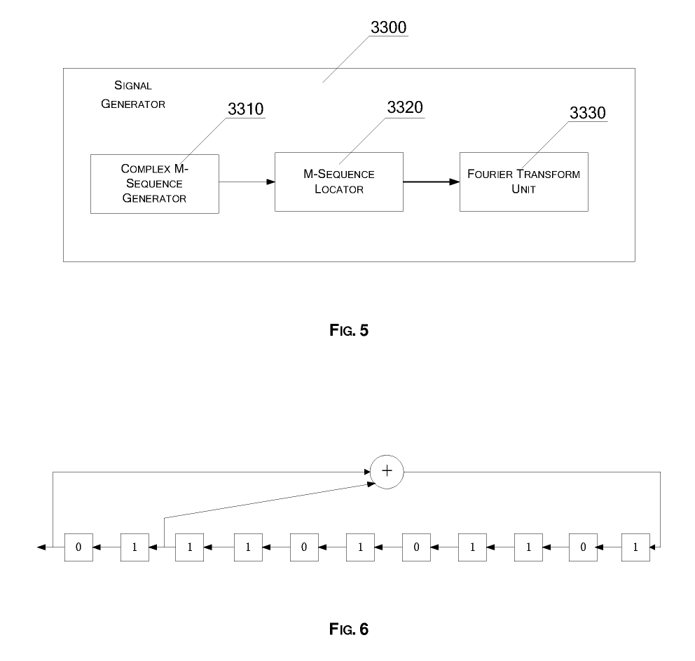

The following description will be given taking a satellite broadcast system 3000 having a sampling rate of 10 MHz and a signal bandwidth of 7.52 MHz as an example. As shown in FIG. 3, the satellite broadcast system 3000 comprises a transmitter 3100 and a receiver 3200. The transmitter 3100 comprises a signal generator 3300 for generating a band-limited random signal. The receiver 3200 comprises a channel estimation device 3400 for performing channel estimation on data based on synchronization signal and pilot. At the transmitter 3100, each frame has duration of 25 ms, containing 250,000 sample points, and has a frame synchronization header of 4096 points composed of two identical frame synchronization sequences each containing 2048 points. As shown in FIG. 4, a frame 400 contains a frame synchronization sequence 410, a frame synchronization sequence 420 and a signal 430. The frame synchronization sequence 410 and the frame synchronization sequence 420 are identical frame synchronization sequences each containing 2048 points.

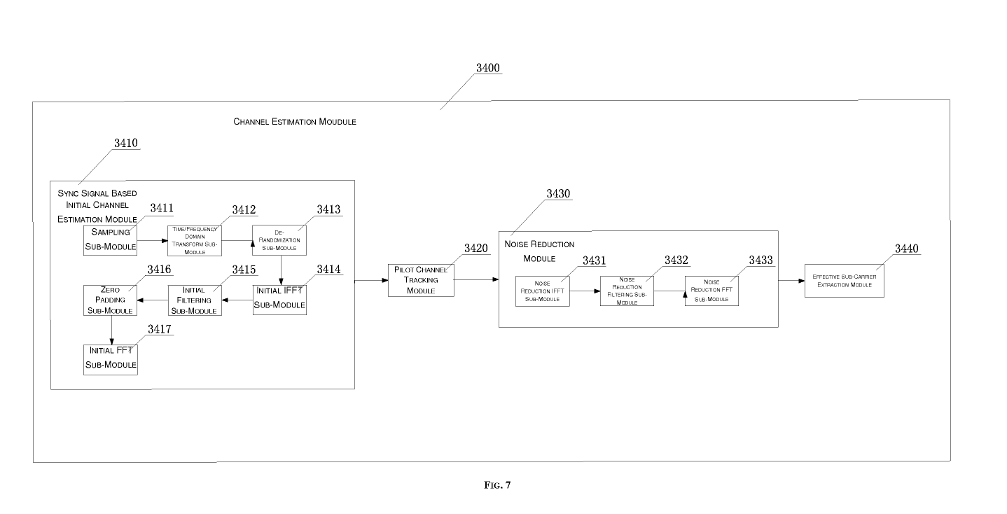

Each of the frame synchronization sequences 410 and 420 is a band-limited random sequence which has a signal bandwidth of 7.52 M and no DC components and is generated based on a truncated m-sequence and inverse Fourier transform. As shown in FIG. 5, the band-limited random signal generator 3300 comprises a complex m-sequence generator 3310, an m-sequence locator 3320 and an inverse Fourier transform unit 3330. The complex m-sequence generator 3310 uses a shift register having a generator polynomial of x¹⁰+x⁹+1 to generate an m-sequence M(k), 0≦k≦2046. As shown in FIG. 6, the initial state of the shift register is 011 1010 1101. Then, the m-sequence is mapped into a complex symbol according to equation (1):

$$L ( k ) = \{ \begin{matrix}1 + 0 j , & M ( k ) = 0 \\ - 1 + 0 j , & M ( k ) = 1\end{matrix} \qquad ( 1 )$$

The m-sequence locator locates the m-sequence to a suitable location in the frequency domain prior to domain transform according to the requirement that the sequence shall have a signal bandwidth of 7.52 M and no DC components. The resulting sequence is expressed in equation (2):

$$P ( k ) = \{ \begin{matrix}0 , & k = 0 \\ L ( k - 1 ) , & 1 \leq k \leq 769 \\ 0 , & 770 \leq k \leq 1278 \\ L ( k - 510 ) , & 1279 \leq k \leq 2047\end{matrix} \qquad ( 2 )$$

The inverse Fourier transform unit 430 transforms equation (2) into the time domain by means of inverse Fourier transform, as shown in equation (3):

$$l ( n ) = IFFT [ P ( k ) ] = \frac{\sqrt{2}}{64} {\sum }_{k = 0}^{2047} P ( k ) \cdot {e}^{j 2 π nk / 2048} , 0 \leq n \leq 2047 \qquad ( 3 )$$

Then, the signal frame is formed in accordance with the structure shown in FIG. 4.

The time domain signal 330 of the satellite broadcast system can be divided into 53 OFDM symbols, each of which employs a 4096-point Inverse Fast Fourier Transform (IFFT) and has 3076 effective sub-carriers. In each OFDM symbol, sub-carriers 0 and 1539-2557 are virtual sub-carriers, whereas sub-carriers 1-1538 and 2558-4095 are effective sub-carriers. Each OFDM symbol contains 384 discrete pilots, 82 continuous pilots and 2610 payload sub-carriers. Each discrete pilot transmits a known symbol of 1+0j. The value of the effective sub-carrier number, m, corresponding to each discrete pilot of the n-th OFDM symbol in each frame can be determined according to the rule as shown in equation (4):

$$if mod ( n , 2 ) == 0 \\ m = \{ \begin{matrix}8 p + 1 , & p = 0 , 1 , 2 , … , 191 \\ 8 p + 3 , & p = 192 , 193 , 194 , … , 383\end{matrix} \\ if mod ( n , 2 ) == 1 \\ m = \{ \begin{matrix}8 p + 5 , & p = 0 , 1 , 2 , … , 191 \\ 8 p + 7 , & p = 192 , 193 , 194 , … , 383\end{matrix} \qquad ( 4 )$$

The continuous pilots can be located at the sub-carriers numbered 0, 22, 78, 92, 168, 174, 244, 274, 278, 344, 382, 424, 426, 496, 500, 564, 608, 650, 688, 712, 740, 772, 846, 848, 932, 942, 950, 980, 1012, 1066, 1126, 1158, 1214, 1244, 1276, 1280, 1326, 1378, 1408, 1508, 1537, 1538, 1566, 1666, 1736, 1748, 1794, 1798, 1830, 1860, 1916, 1948, 2008, 2062, 2094, 2124, 2132, 2142, 2226, 2228, 2302, 2334, 2362, 2386, 2424, 2466, 2510, 2574, 2578, 2648, 2650, 2692, 2730, 2796, 2800, 2830, 2900, 2906, 2982, 2996, 3052 and 3075, respectively. FIG. 2 shows the structure in which the discrete pilots, the continuous pilots and the payloads are multiplexed in the time/frequency domain.

As shown in FIG. 7, the channel estimation device 3400 in the receiver 3200 comprises:
a synchronization signal based initial channel estimation module 3410 for performing initial channel estimation based on a synchronization signal in the data; a pilot channel tracking module 3420 for performing pilot channel tracking on the result of the initial channel estimation based on a pilot in the data; a noise reduction module 3430 for performing noise reduction on the result of the pilot channel tracking; and an effective sub-carrier extraction module 3440 for extracting channel estimation values of effective sub-carriers from the result of the noise reduction. The synchronization signal based initial channel estimation module 3410 comprises: a sampling sub-module 3411 for sampling a frame synchronization sequence; a time/frequency domain transform sub-module 3412 for performing time/frequency domain transform; a de-randomization sub-module 3413 for de-randomization; an initial IFFT sub-module 3414 for performing IFFT operation; an initial filtering sub-module 3415 for performing noise reduction; a zero padding sub-module 3416 for zero padding; and an initial FFT sub-module 3417 for performing Fast Fourier Transform (FFT) operation. The noise reduction module 3430 comprises: a noise reduction IFFT sub-module 3431 for performing IFFT operation; a noise reduction filtering sub-module 3432 for performing noise reduction filtering; and a noise reduction FFT sub-module 3433 for performing FFT operation.

Herein, the sampling sub-module 3411 acquires, from the starting location of the frame synchronization sequence of the data, 2048 sample points denoted by b(n) , at a sampling rate of 10 MHz. The time/frequency domain transform sub-module 3412 transforms b(n) into B(k) according to equation (5):

$$B ( k ) = FFT [ b ( n ) ] = \frac{\sqrt{2}}{64} {\sum }_{n = 0}^{2047} b ( n ) \cdot {e}^{- j 2 π nk / 2048} , 0 \leq k \leq 2047 \qquad ( 5 )$$

The de-randomization sub-module 3413 performs frequency domain sequence de-randomization on B(k) using a sequence-located random sequence P(k) which is the same as that of the transmitter to obtain R(k) according to equation (6):

R(k)=B(k)·P(k), 0≦k≦2047 (6)

The initial IFFT sub-module 3414 performs IFFT operation on R(k) to obtain a channel impulse response r(n) with noise according to equation (7):

$$r ( n ) = IFFT ( R ( k ) ] = \frac{\sqrt{2}}{64} {\sum }_{k = 0}^{2047} R ( k ) \cdot {e}^{j 2 π nk / 2048} , 0 \leq n \leq 2047 \qquad ( 7 )$$

The initial filtering sub-module 3415 calculates the power of r(n) according to equation (8):

$${P}_{aveg} = \frac{1}{2048} {\sum }_{k = 0}^{2047} {\vert r ( n ) \vert}^{2} \qquad ( 8 )$$

and performs noise reduction on r(n) to obtain a noise reduced channel impulse response s(n) according to equation (9):

$$s ( n ) = \{ \begin{matrix}r ( n ) , & {\vert r ( n ) \vert}^{2} \geq 2 {P}_{aveg} \\ 0 , & {\vert r ( n ) \vert}^{2} < 2 {P}_{aveg}\end{matrix} \qquad ( 9 )$$

The zero padding sub-module 3416 zero pads s(n) based on the fact that the synchronization signal has 2048 sub-carriers and the time domain signal has 4096 sub-carriers to obtain equation (10):

$$t ( n ) = \{ \begin{matrix}s ( n ) , & 0 \leq n \leq 1023 \\ 0 , & 1024 \leq n \leq 3071 \\ s ( n - 2048 ) , & 3072 \leq n \leq 4095\end{matrix} \qquad ( 10 )$$

The initial FFT sub-module 3417 performs FFT operation on the result of zero padding to obtain the synchronization signal based initial channel estimation H₀(k) according to equation (11):

$${H}_{0} ( k ) = \sqrt{2} FFT [ t ( n ) ] = \frac{\sqrt{2}}{64} {\sum }_{n = 0}^{4095} t ( n ) \cdot {e}^{- j 2 π nk / 4096} , \\ 0 \leq k \leq 4095 \qquad ( 11 )$$

The pilot channel tracking module 3420 performs pilot channel tracking process according to equation (12):

$${H}_{i} ( k ) = \{ \begin{matrix}{H}_{i - 1} ( k ) , & if k is not a discrete pilot point \\ {Q}_{i} ( k ) , & if k is a discrete pilot point\end{matrix} \qquad ( 12 )$$

where Qᵢ(k) is the frequency domain signal received at the discrete pilot point in the i-th (1≦i≦53) OFDM symbol and Hᵢ(k) is the channel estimation value after pilot channel tracking on the i-th OFDM symbol.

The noise reduction IFFT sub-module 3431 performs IFFT operation on the result Hᵢ(k) of the pilot channel tracking to obtain a noisy channel impulse response hᵢ(n) according to equation (13):

$${h}_{i} ( n ) = IFFT [ {H}_{i} ( k ) ] = \frac{1}{64} {\sum }_{k = 0}^{4095} {H}_{i} ( k ) \cdot {e}^{j 2 π n k / 4096} , 0 \leq n \leq 4095 \qquad ( 13 )$$

The noise reduction filtering sub-module 3432 calculates the average power of hᵢ(n) according to equation (14):

$${P}_{aveg , i} = \frac{1}{4096} {\sum }_{k = 0}^{4095} {\vert {h}_{i} ( n ) \vert}^{2} \qquad ( 14 )$$

and performs noise reduction on hᵢ(n) to obtain a noise reduced channel impulse response \tilde{h}ᵢ(n) according to equation (15):

$${\tilde{h}}_{i} ( n ) = \{ \begin{matrix}{h}_{i} ( n ) , & {\vert {h}_{i} ( n ) \vert}^{2} \geq 2 {P}_{aveg , i} \\ 0 , & {\vert {h}_{i} ( n ) \vert}^{2} < 2 {P}_{aveg , i}\end{matrix} \qquad ( 15 )$$

The noise reduction FFT sub-module 3433 performs FFT operation on hᵢ(n) to obtain a noise reduced channel estimation value \tilde{H}ᵢ(k) according to equation (16):

$$\tilde{{H}_{i}} ( k ) = FFT [ {\tilde{h}}_{i} ( n ) ] = \frac{1}{64} {\sum }_{n = 0}^{4095} {\tilde{h}}_{i} ( n ) \cdot {e}^{- j 2 π nk / 4096} , 0 \leq k \leq 4095 \qquad ( 16 )$$

The effective sub-carrier extraction module 3440 extracts from the noise reduced channel estimation value Hᵢ(k) the channel estimation values of the effective sub-carriers according to equation (17):

$${\dot{H}}_{i} ( k ) = \{ \begin{matrix}{\tilde{H}}_{i} ( k + 1 ) , & 0 \leq k \leq 1537 \\ {\tilde{H}}_{i} ( k + 1020 ) , & 1538 \leq k \leq 3075\end{matrix} \qquad ( 17 )$$

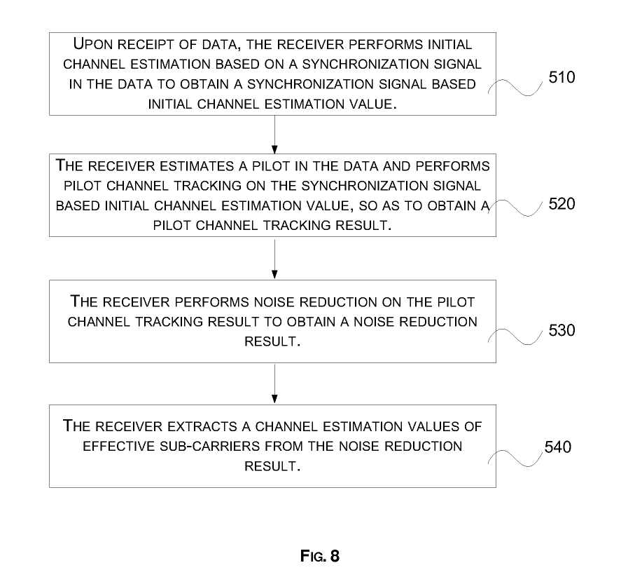

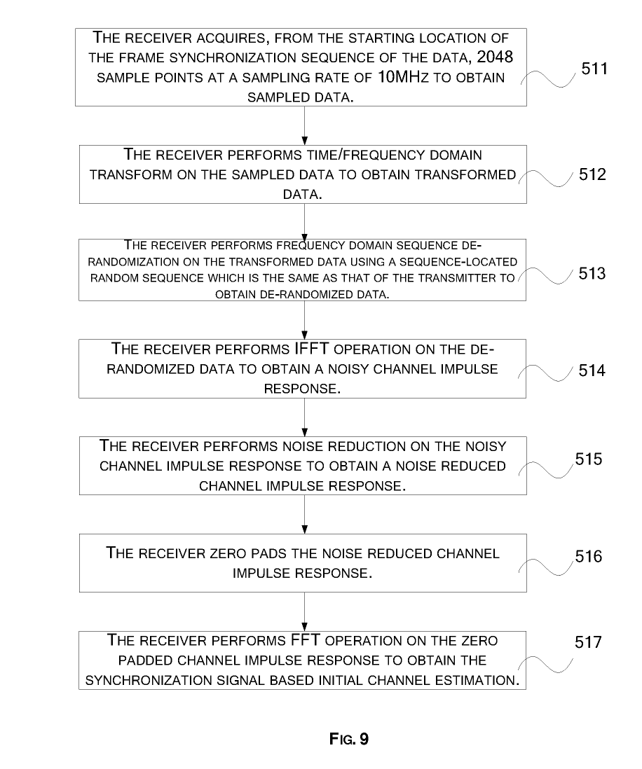

FIG. 8 is a flowchart illustrating the channel estimation method according to an embodiment of the present invention. As shown, the method comprises the following steps.

At step S510, upon receipt of data, the receiver performs initial channel estimation based on a synchronization signal in the data to obtain a synchronization signal based initial channel estimation value.

At step S520, the receiver estimates a pilot in the data and performs pilot channel tracking on the synchronization signal based initial channel estimation value, so as to obtain a pilot channel tracking result.

At step S530, the receiver performs noise reduction on the pilot channel tracking result to obtain a noise reduction result.

At step S540, the receiver extracts channel estimation values of effective sub-carriers from the noise reduction result.

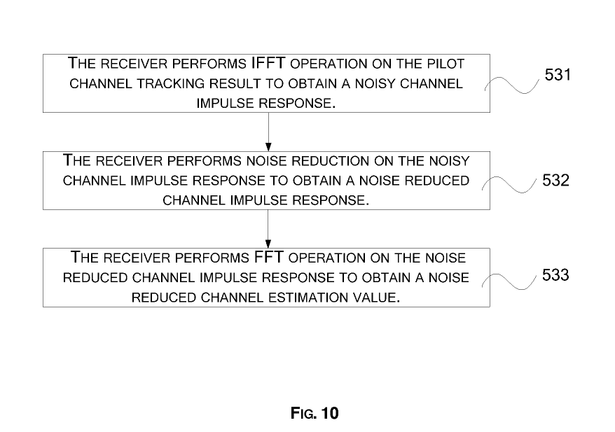

FIG. 9 shows a flowchart further illustrating the step S510 in which the initial channel estimation is carried out based on the synchronization signal in the data. As shown, the step S510 further comprises the following steps.

At step S511, the receiver acquires, from the starting location of the frame synchronization sequence of the data, 2048 sample points at a sampling rate of 10 MHz to obtain sampled data.

At step S512, the receiver performs time/frequency domain transform on the sampled data to obtain transformed data.

At step S513, the receiver performs frequency domain sequence de-randomization on the transformed data using a sequence-located random sequence which is the same as that of the transmitter to obtain de-randomized data.

At step S514, the receiver performs IFFT operation on the de-randomized data to obtain a noisy channel impulse response.

At step S515, the receiver performs noise reduction on the noisy channel impulse response to obtain a noise reduced channel impulse response.

At step S516, the receiver zero pads the noise reduced channel impulse response based on the fact that the synchronization signal has 2048 sub-carriers and the time domain signal has 4096 sub-carriers.

At step S517, the receiver performs FFT operation on the zero padded channel impulse response to obtain the synchronization signal based initial channel estimation.

FIG. 10 shows a flowchart further illustrating the step S530 in which the receiver performs noise reduction process on the pilot channel tracking result. As shown, the step S530 further comprises the following steps.

At step S531, the receiver performs IFFT operation on the pilot channel tracking result to obtain a noisy channel impulse response.

At step S532, the receiver performs noise reduction on the noisy channel impulse response to obtain a noise reduced channel impulse response.

At step S533, the receiver performs FFT operation on the noise reduced channel impulse response to obtain a noise reduced channel estimation value.

With the channel estimation method and device for OFDM system according to the present invention, the channel estimation is carried out jointly based on the synchronization signal and the pilot, such that the accuracy of channel estimation can be significantly improved and the performance requirements of the system can be satisfied without increasing the density of pilots and thus reducing the amount of system payload. Moreover, the synchronization signal can still be used for its original purpose of carrier and timing synchronization, such that the original function of the synchronization is not affected.

While the embodiments of the present invention have been shown and described, various changes, modifications, alternatives and variants can be made to the embodiments by those skilled in the art without departing from the principle and spirit of the present invention. The scope of the present invention is only defined by the claims as attached and the equivalents thereof.

What is claimed is:

1. A channel estimation device for an OFDM system, configured for performing channel estimation on data based on synchronization signal and pilot, comprising:
a synchronization signal based initial channel estimation module adapted for performing initial channel estimation based on a synchronization signal in the data to obtain an initial channel estimation result;
a pilot channel tracking module adapted for performing pilot channel tracking on the initial channel estimation result obtained from the synchronization signal based initial channel estimation module based on a pilot in the data, so as to obtain a pilot channel tracking result;
a noise reduction module adapted for performing noise reduction on the pilot channel tracking result obtained from the pilot channel tracking module; and
an effective sub-carrier extraction module adapted for extracting channel estimation values of effective sub-carriers from the noise reduced pilot channel tracking result.

2. The channel estimation device according to claim 1, wherein the synchronization signal based initial channel estimation module further comprises:
a sampling sub-module adapted for sampling a frame synchronization sequence of the data to obtain the sampled data;
a time/frequency domain transform sub-module adapted for performing time/frequency domain transform on the sampled data obtained from the sampling sub-module to obtain transform domain data;
a de-randomization sub-module adapted for de-randomizing the transform data obtained from the time/frequency domain transform sub-module to obtain de-randomized data;
an initial IFFT sub-module adapted for performing IFFT operation on the de-randomized data obtained from the de-randomization sub-module to obtain initial IFFT data;
an initial filtering sub-module adapted for performing noise reduction on the initial IFFT data obtained from the initial IFFT sub-module to obtain an initial noise reduction result;
a zero padding sub-module adapted for zero padding the initial noise reduction result obtained from the initial filtering sub-module to obtain a zero padded result; and
an initial FFT sub-module adapted for performing FFT operation on the zero padded result obtained from the zero padding sub-module to obtain the initial channel estimation result.

3. The channel estimation device according to claim 1, wherein the noise reduction module further comprises:
a noise reduction IFFT sub-module adapted for performing IFFT operation on the pilot channel tracking result obtained from the pilot channel tracking module to obtain noise reduced IFFT data;
a noise reduction filtering sub-module adapted for performing noise reduction filtering on the noise reduced IFFT data obtained from the noise reduction IFFT filtering sub-module to obtain a noise reduction filtered result; and
a noise reduction FFT sub-module adapted for performing FFT operation on the noise reduction filtered result obtained from the noise reduction filtering sub-module to obtain a noise reduction result.

4. A channel estimation method for an OFDM system, for performing channel estimation on data based on synchronization signal and pilot, comprising the steps of:
performing initial channel estimation based on a synchronization signal in the data to obtain an initial channel estimation result;
performing pilot channel tracking on the initial channel estimation result based on a pilot in the data, so as to obtain a pilot channel tracking result;
performing noise reduction on the pilot channel tracking result to obtain a noise reduction result; and
extracting channel estimation values of effective sub-carriers from the noise reduction result.

5. The channel estimation method according to claim 4, wherein the step of performing initial channel estimation based on a synchronization signal in the data to obtain an initial channel estimation result comprises:
sampling a frame synchronization sequence of the data to obtain sampled data;
performing time/frequency domain transform on the sampled data to obtain transform domain data;
de-randomizing the transform data to obtain de-randomized data;
performing IFFT operation on the de-randomized data to obtain initial IFFT data;
performing noise reduction on the initial IFFT data to obtain an initial noise reduction result;
zero padding the initial noise reduction result to obtain a zero padded result; and
performing FFT operation on the zero padded result to obtain the initial channel estimation result.

6. The channel estimation method according to claim 4, wherein the step of performing noise reduction on the pilot channel tracking result to obtain a noise reduction result comprises:
performing IFFT operation on the pilot channel tracking result to obtain noise reduced IFFT data;
performing noise reduction filtering on the noise reduced IFFT data to obtain a noise reduction filtered result; and
performing FFT operation on the noise reduction filtered result to obtain the noise reduction result.

7. An OFDM-based multi-carrier digital broadcast system comprising a transmitting device and a receiving device, wherein the system further comprises a channel estimation device adapted for performing channel estimation on data received by the receiving device based on synchronization signal and pilot.

8. The multi-carrier digital broadcast system according to claim 7, wherein the channel estimation device further comprises:
a synchronization signal based initial channel estimation module adapted for performing initial channel estimation based on a synchronization signal in the data to obtain an initial channel estimation result;
a pilot channel tracking module adapted for performing pilot channel tracking on the initial channel estimation result obtained from the synchronization signal based initial channel estimation module based on a pilot in the data, so as to obtain a pilot channel tracking result;
a noise reduction module adapted for performing noise reduction on the pilot channel tracking result obtained from the pilot channel tracking module; and
an effective sub-carrier extraction module adapted for extracting channel estimation values of effective sub-carriers from the noise reduced pilot channel tracking result.

9. The multi-carrier digital broadcast system according to claim 8, wherein the synchronization signal based initial channel estimation module further comprises:
a sampling sub-module adapted for sampling a frame synchronization sequence of the data to obtain sampled data;
a time/frequency domain transform sub-module adapted for performing time/frequency domain transform on the sampled data obtained from the sampling sub-module to obtain transform domain data;
a de-randomization sub-module adapted for de-randomizing the transform data obtained from the time/frequency domain transform sub-module to obtain de-randomized data;
an initial IFFT sub-module adapted for performing IFFT operation on the de-randomized data obtained from the de-randomization sub-module to obtain initial IFFT data;
an initial filtering sub-module adapted for performing noise reduction on the initial IFFT data obtained from the initial IFFT sub-module to obtain an initial noise reduction result;
a zero padding sub-module adapted for zero padding the initial noise reduction result obtained from the initial filtering sub-module to obtain a zero padded result; and
an initial FFT sub-module adapted for performing FFT operation on the zero padded result obtained from the zero padding sub-module to obtain the initial channel estimation result.

10. The multi-carrier digital broadcast system according to claim 8, wherein the noise reduction module further comprises:
a noise reduction IFFT sub-module adapted for performing IFFT operation on the pilot channel tracking result obtained from the pilot channel tracking module to obtain noise reduced IFFT data;
a noise reduction filtering sub-module adapted for performing noise reduction filtering on the noise reduced IFFT data obtained from the noise reduction IFFT filtering sub-module to obtain a noise reduction filtered result; and
a noise reduction FFT sub-module adapted for performing FFT operation on the noise reduction filtered result obtained from the noise reduction filtering sub-module to obtain a noise reduction result.
